(19) United States
(12) Patent Application Publication
(10) Pub. No.: US 2002/0009018 A1
(43) Pub. Date: Jan. 24, 2002

(54) Conditioning device

(76) Inventor: Nicholas P. Patella, Winston-Salem, NC (US)

Correspondence Address: Charles Y. Lackey, Post Office Box 5871, Winston-Salem, NC, 27113-5871, US

(21) Appl. No.: 09/876,759

(22) Filed: Jun. 9, 2001

Related U.S. Application Data
(63) Continuation-in-part of application No. 09/334,058, filed on Aug. 20, 1999, now abandoned.

(51) Int. Cl. G04C 21/00; G04C 23/00; G04B 23/02; G04F 8/00; G04F 10/00

(52) U.S. Cl. 368/108; 368/73

(57) ABSTRACT

A device for conditioning children to perform special tasks that utilizes a generated signal controlled by a central processor unit (“CPU”) which acts to, among other things, establish normal time intervals so that the signal is activated at the end of that interval. An accomplishment switch will signal and reset the timer to the normal time interval when activated. A clock is associated with the CPU to show the time remaining before the next signal activation, and visual means is provided to display timer intervals and real time. The generated signal can be audible, visual, or vibratory, or combinations thereof, and visual means can be utilized with the device to selectively display graphics during the time interval and/or upon its termination. A reward feature is incorporated in or with the device to encourage a willingness to participate on the part of the child or children being trained.

This application is a continuation-in-part application based on pending patent application Ser. No. 09/334,058 filed Aug. 20, 1999.

### BACKGROUND OF THE INVENTION

This application is a continuation-in-part application of my pending application Ser. No. 09/334,058 filed Aug. 20, 1999.

1. Field of the Invention

This invention relates to a conditioning device and more particularly to a device for conditioning children to perform special tasks such as bathroom visits during potty-training.

2. Description of the Prior Art

The prior art contains numerous references to devices which prompt the user to perform a certain activity at a scheduled time. Devices and procedures are known for reminding a patient when to take medicine, for keeping track of appointments, for activating security systems, appliances and other controllable devices. Some of these include recording systems involving writing materials. The more involved prior art references involve electronic reminder systems.

In U.S. Pat. No. 4,490,711, a programmable alarm device is provided to remind people on medication when to take the medication. This device is intended to be programmed for a selected number of alarms per day by elderly and incapacitated people who have no computer or electronic watch programming experience. It is constructed so that the user can easily ascertain what program schedule has been programmed and what should occur at the alarm times. The device can control the dispensing of medication and record how often the device alarm sounds and is silenced by the user. Although this device provides an alarm to prompt the user to perform an activity, it makes no allowance for offsetting or adjusting the alarm in the event the user fails to perform the activity.

In conditioning, training or disciplining children, a device like that described above has limited use since the timer cannot be adjusted or corrected in the event the activity is not performed. Children seldom can take naps or use the bathroom on command, therefore this flexibility is essential in order to make such a conditioning device effective.

U.S. Pat. No. 5,365,496, addresses this need for resetting the timer in the event the activity does not take place, however, it uses an offset timer which must be manually adjusted. It also includes an interval calculator to perform calculations by averaging the time intervals of a predetermined number of events. The manual adjustment is distracting and likely to be overlooked from time to time, consequently there is a need for more automation in such a device and other more effective features to hold the user's attention and to provide other conveniences associated therewith. It is to these additional needs that the present invention is directed.

### OBJECTIVES AND SUMMARY OF THE INVENTION

A primary objective of the present invention is to provide a conditioning device for training children to perform special tasks such as bathroom visits during potty-training.

Another primary objective of the present invention is to provide the user with a timer that will automatically recycle for preselected shorter time intervals in the event a scheduled event does not take place during the first normal time interval.

Another objective of the present invention is to provide a conditioning device utilizing either audible, visual or vibratory signaling devices or combination thereof.

Still another objective of the present invention is to provide a conditioning devices of the type described which will produce a preliminary alert signal to indicate that a normal time interval signal will be activated shortly.

A further objective of the present invention is to provide a conditioning device of the type described which will include visual means of displaying such graphics or animation during and at the end of the normal time interval or a graphic of popular reference positioned behind the graphics display during the normal time interval.

Yet another objective of the present invention is to provide a conditioner of the type described which includes an accomplishment switch operable by the child upon completion of the signaled activity that will activate a voice acknowledgement of the child's activity, reset the timer to complete another normal time interval, and may provide a physical reward for good performance such as teaching toilet paper (printed paper with puzzles, school graphics, etc.), wrapped candy or other prizes and the like.

Still another further objective of the present invention is to provide a conditioner of the type described which includes a contoured elliptical housing within which is positioned the signaling circuit and the timer and on or adjacent to which is placed the accomplishment switch, a microphone, a speaker, a hanger, a graphics display, and a clip for maintaining the device against independent movement.

The invention is a conditioning device to assist and train children to perform special tasks which includes a signal circuit, a timer connected to the signal circuit for setting a normal time interval and activating the signal circuit at the end of the time interval, the timer including means for automatically initiating a selected number of additional shorter time intervals; and an accomplishment switch operable with the timer to interrupt and reset the timer to the normal time interval when activated. A graphics display is operably connected with the timer and accomplishment switch and will display, when activated, a menu of variable functions such as real time, period time, characters (graphics and animation), record, audio and others. The produced signal can be audible, visual or associated with movement such as that caused by a vibrator or any combination of these features. The timer also is capable of producing one or more initial alert signals to indicate that a time interval signal will follow soon thereafter. A reward feature can be associated with device to provide physical articles in return for a good performance.

Thus, there has been outlined the more important features of the invention in order that the detailed description that follows may be better understood and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the arrangement of the components set forth in the following description or illustrated in the drawings. The invention is capable of other embodiments and in being practiced and carried out in various ways.

It is also to be understood that the phraseology and terminology employed herein are for the purpose of description and should not be regarded as limiting in any respect. Those skilled in the art will appreciate the concept upon which this disclosure is based and that it may readily be utilized as a basis for designing other structures, methods and systems for carrying out the several purposes of this development. It is important that the claims be regarded as including such equivalent methods and products resulting therefrom so long as they do not depart from the spirit and scope of the present invention. The application is neither intended to define the invention which is measured by its claims, nor to limit its scope in any way.

Thus, the objectives of the invention previously set forth, along with the various features of novelty which characterize the invention, are noted with particularity in the claims annexed to and forming a part of this disclosure. For a better understanding of the invention, its operating advantages, and the specific results obtained by its use, reference is made to the following detailed description taken in conjunction with the accompanying drawings wherein like characters of reference designate like parts throughout the several views.

### BRIEF DESCRIPTION OF THE DRAWINGS

FIG. 1 is a front elevational view of the conditioning device comprising the present invention;

FIG. 2 is a first side elevational view of the conditioning device shown in FIG. 1;

FIG. 3 is an elevational view of the other side of the conditioning device shown in FIG. 1;

FIG. 4 is a top plan view of the device shown in FIG. 1;

FIG. 5 is a bottom plan view of the device shown in FIG. 1;

FIG. 6 is a rear elevational view of the device shown in FIG. 1;

FIG. 7 is a block schematic diagram of the conditioning device comprising the present invention;

FIG. 8 is a front elevational view of the conditioning device of FIG. 1 in default condition;

FIG. 9 is a rear elevational view of the conditioning device of FIG. 1 with the graphics display displaying current time and the normal intervals;

FIG. 10 is a rear elevational view of the conditioning device of FIG. 1 with the graphics display displaying the initial call-up menu showing individual functions of the device;

FIG. 11 is a rear elevational view of the device of FIG. 1 showing the current time when operationally sequenced from the menu in FIG. 8 with the current time hour being programmed;

FIG. 12 is a rear elevational view of the device of FIG. 1 with minutes of the current time being programmed;

FIG. 13 is a rear elevational view of the device of FIG. 1 showing the timer selection screen when sequenced from the menu in FIG. 8;

FIG. 14 is a rear elevational view of the device of FIG. 1 showing the timer sub menu selected screen;

FIG. 15 is a rear elevational view of the device of FIG. 1 showing the auto timer selected screen with the hour being programmed;

FIG. 16 is a rear elevational view of the device of FIG. 1 showing the auto timer selected screen with the minutes being programmed;

FIG. 17 is a rear elevational view of the device of FIG. 1 showing the self timer selected screen with the hour being programmed;

FIG. 18 is a rear elevational view of the device of FIG. 1 showing the self timer selected screen with minutes being programmed;

FIG. 19 is a rear elevational view of the device of FIG. 1 showing the characters selection screen when sequenced from the menu in FIG. 8;

FIG. 20 is a rear elevational view of the device of FIG. 1 showing the characters available (graphics and animation) when operationally sequenced from the menu in FIG. 8;

FIG. 21 is a rear elevational view of the device shown in FIG. 1 with the graphics selection being chosen;

FIG. 22 is a rear elevational view of the device shown FIG. 1 with the animation selection being chosen;

FIG. 23 is a rear elevational view of the device shown FIG. 1 showing record option when individually sequenced from the menu in FIG. 8;

FIG. 24 is a rear elevational view of the device shown in FIG. 1 showing the announcement reward selection screen;

FIG. 25 is a rear elevational view of the device shown in FIG. 1 with the announcement being selected and received by the device;

FIG. 26 is a rear elevational view of the device shown in FIG. 1 with the announcement being played back for revision or acceptance;

FIG. 27 is a rear elevational view of the device of FIG. 1 with the reward option being selected and reward message being recorded;

FIG. 28 is a rear elevational view of the device of FIG. 1 with the reward message being played back for correction or acceptance;

FIG. 29 is a rear elevational view of the device of FIG. 1 showing the volume/vibe selection screen when sequenced from the menu in FIG. 8;

FIG. 30 is a rear elevational view of the device of FIG. 1 showing the volume selected screen with the volume intensity being programmed;

FIG. 31 is a rear elevational view of the device of FIG. 1 showing the vibration selected screen with the vibration function being active;

FIG. 32 is a rear elevational view of the device of FIG. 1 showing the off/pause selection screen when operationally sequenced from the menu in FIG. 8;

FIG. 33 is a rear elevational view of the device of FIG. 1 showing the off/pause selected screen with the off function being programmed;

FIG. 34 is a rear elevational view of the device of FIG. 1 showing the vocal deactivation of the device;

FIG. 35 is a rear elevational view of the device of FIG. 1 with the screen showing current time and a steady reflection of a character during a pause or inactive period;

FIG. 36 is a rear elevational view of the device of FIG. 1 when reactivated;

FIG. 37 is a rear elevational view of the device of FIG. 1 with the device in the reactivated condition;

FIG. 38 is a rear elevational view of the device of FIG. 1 showing the language selection feature when operationally sequenced from the menu in FIG. 8;

FIG. 39 is a rear elevational view of the device of FIG. 1 showing the Swedish language being programmed;

FIG. 40 is a graphic display of the functions and operations of the present invention;

FIG. 41 is a rear elevational view of a hangup comic character to which may be attached or within which may be installed the device comprising the present invention;

FIG. 42 is a perspective view of a stuffed animal upon or within which is attached or installed the device comprising the present invention;

FIG. 43 is a perspective view of a plurality of positionable locations n children-related articles for the device of the present invention;

FIG. 44 is a perspective view of a diaper bag to which may be attached or with which may be manufactured the device comprising the present invention;

FIG. 45 is a perspective view of a cleaning container to which may be attached or installed the device comprising the present invention;

FIG. 46 is a perspective view of one form of a stand along toddler's toilet to which may be secured or installed the device of the present invention;

FIG. 47 is a perspective view of another form of toddler's toilet seat upon which may be attached to or made within the device comprising the present invention which is pressure activated when successful activity occurs;

FIG. 48 is a perspective view of yet another toilet seat attachment to or within which may be secured or installed the device of the present invention;

FIG. 49 is a perspective view of a conventional toilet to which is affixed steps or a ladder for use by a small child and upon or within which can be affixed or installed the device comprising the present invention;

FIG. 50 is a front elevational view of a wall mounted paper dispenser to which is attached the conditioning device of the present invention along with paper dispensing device holding a special reward paper (with graphic, puzzles, etc.) included to further instill a willingness to participate on the part of the child;

FIG. 51 is a side elevational view of the device shown in Fig.50;

FIG. 52 is a front elevational view of a paper dispenser supporting a chalk board and the conditioning device of the present invention;

FIG. 53 is a side elevational view of the device shown in FIG. 52;

FIG. 54 is a front elevational view of paper dispenser supporting the conditioning device of the present invention together with an internet connection with conditioning device in the rest position;

FIG. 55 is a front elevational view of the device of FIG. 54 with the conditioning device and internet connection in the active condition;

FIG. 56 is a side elevational view of the device shown in FIG. 54;

FIG. 57 is a front elevational view of a paper dispenser in combination with selectively openable holding dervice in combination with the conditioning device of the present invention;

FIG. 58 is a side elevational view of the device shown in FIG. 57;

FIG. 59 is holding device designed to open or be opened selectively by the conditioning device of the present invention and provide rewards like candy or gum to the child being trained in return for a good performance; and

FIG. 60 is a side elevational view of the device shown in FIG. 60.

### DETAILED DESCRIPTION OF THE PREFERRED EMBODIMENT

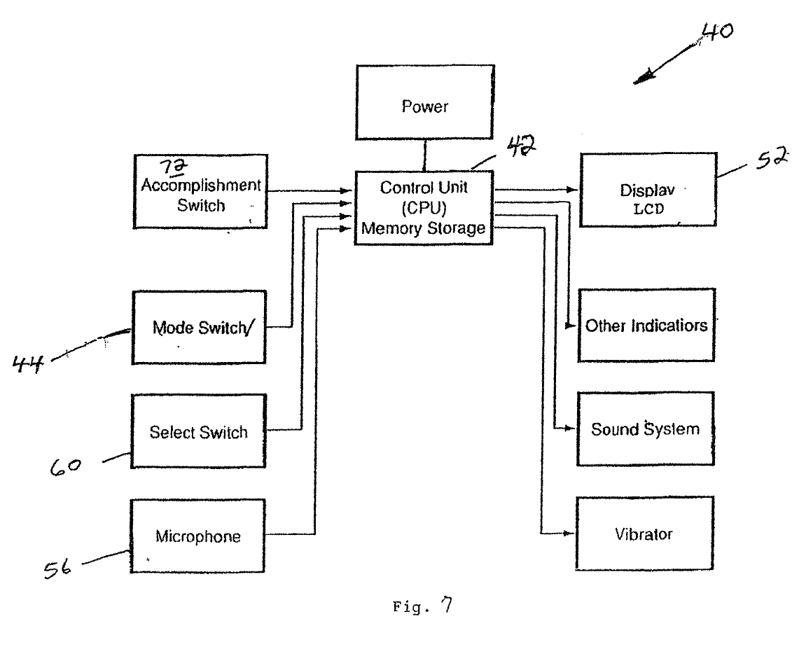

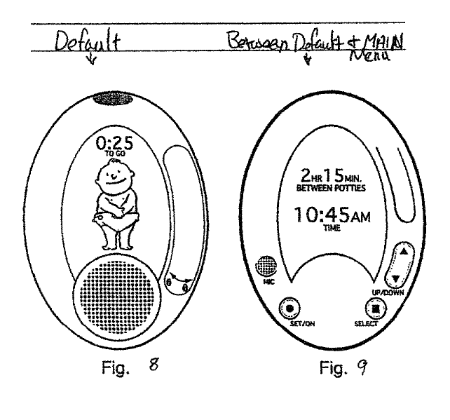

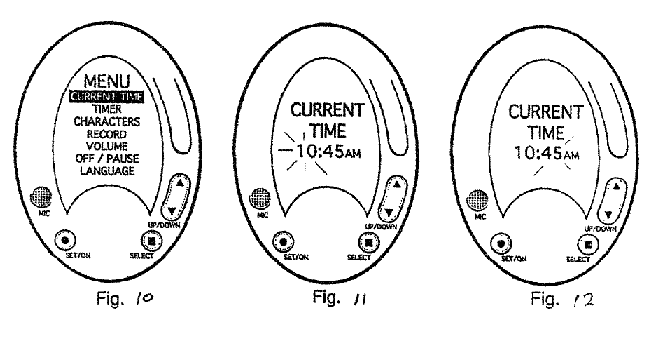

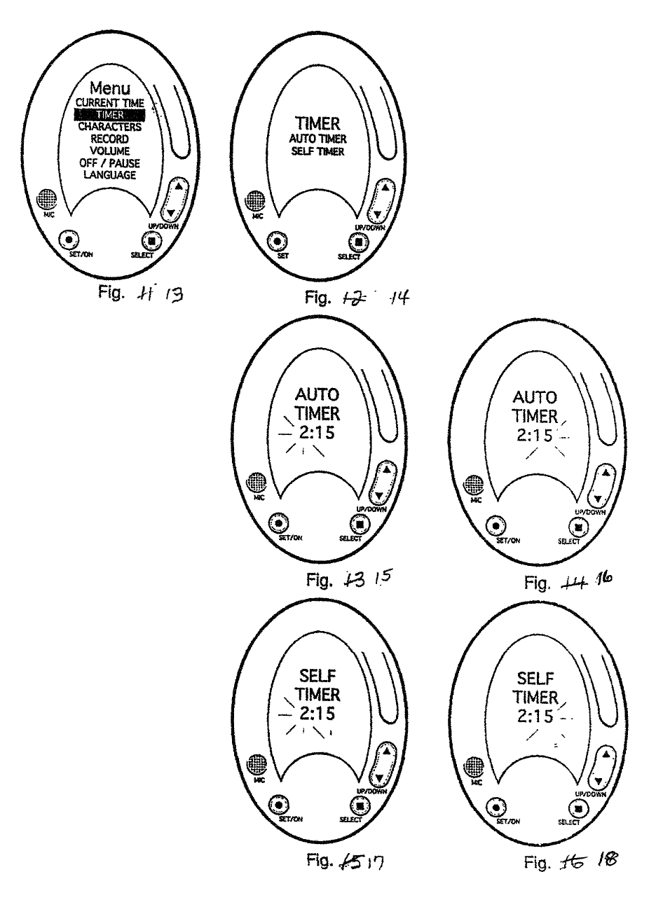

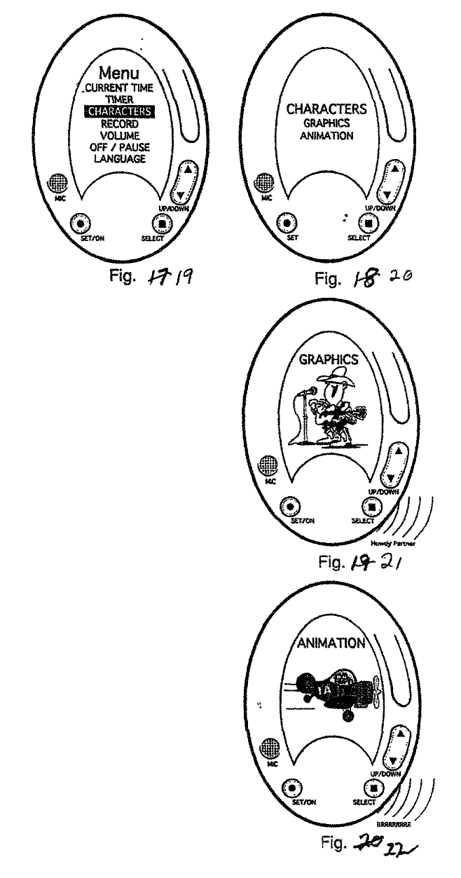

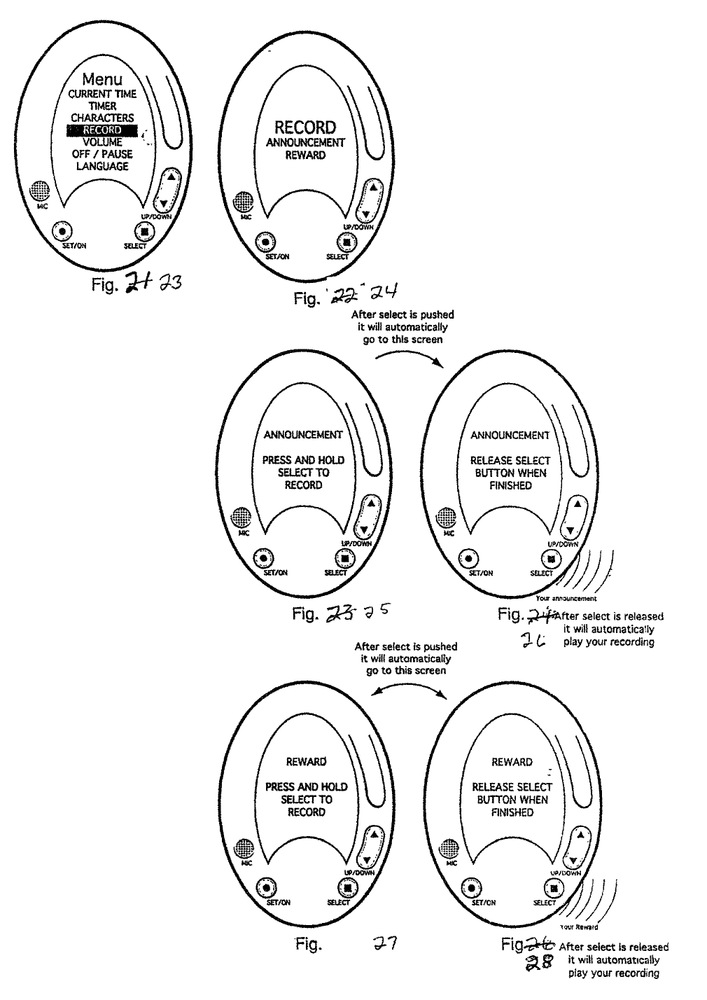

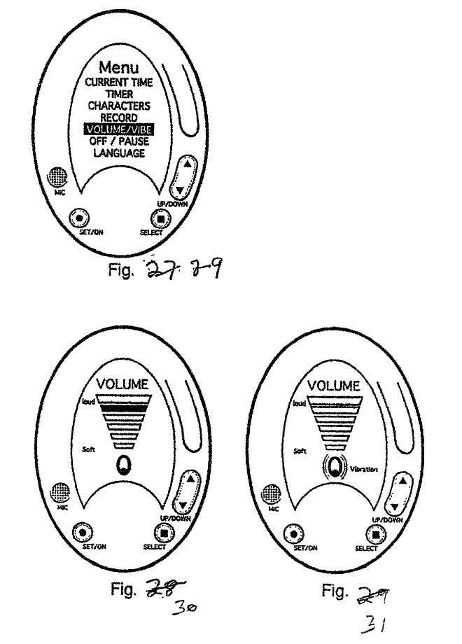

Referring now the drawings and particularly to FIG. 7, the conditioning device of the present invention is shown generally as 40 and includes a CPU 42 which receives and distributes input and output signals for the overall operation of the device. A mode switch 44 inputs to CPU 42 to provide the ability to selectively change various inputs to CPU 42 as needed.

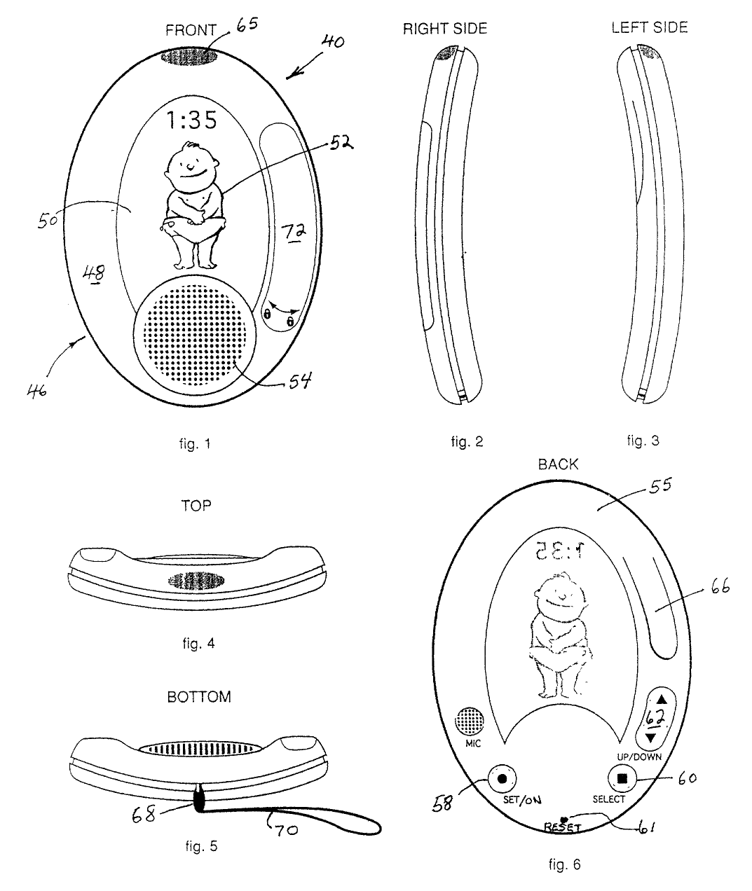

Device 40 preferably in physical form takes an elliptical shape like that shown in FIGS. 1 and 2 wherein a housing shown generally as 46 is formed of an elliptical shell 48 having a central opening 50 within which is provided a transparent graphics display 52. A microphone/speaker 54 is positioned near opening 50 and shell 48. Switches controlling various functions and circuit elements are recessed into the surface of the reverse side 55 of shell 48 and are best shown in FIG. 6. The microphone/speaker 56, the set switch 58, the select switch 60, and the raise and lower scroll switches 62 are all conveniently located near each other. Selection control of graphics display 52 is achieved by programmed operation of select switch 60 and set switch 58 to display graphics or animation on graphics display 52 selectively. Switches 58 and 60 also control the provision of voice or sounds at selected times by the device 40 through microphone/speaker 54. An accomplishment switch 72 is positioned on the rear side of shell 48.

The various features of device 40 will now be demonstrated as set switch 58 provides the input options for each function on graphics display 52 and for the recordation, input and playback of each audible signal.

When device 40 is in a non-operable demo mode, an LED 65 positioned on shell 48 flashes continuously. When the device is activated, LED 65 goes off and stays in that condition until the device 40 is activated and the first pre-warning period is reached at which time it again begins to flash continuously through the reset activation.

When in the default condition, the graphics display of device 40 appears as shown in FIG. 8 with the figure of the child and the time to go within a cycle remaining on the graphics display. When device 40 is actuated to pull up the menu of FIG. 8, the short interval of time between the time set switch is depressed and the time the menu appears causes the activation of the screen as shown in FIG. 9 wherein the current time and the time between events is displayed for that interval. Thus device 40 functions as a clock anytime set switch 58 is depressed.

The timer circuit for emitting one or more programmed signals to initiate the activity desired by the child or participant being potty-trained or otherwise instructed, will appear as shown in FIGS. 11-16 wherein choices of AUTO TIME or SELF TIME are available. Additionally, REAL TIME or CURRENT TIME can be set by pressing set switch 58, scrolling via switch 62 to CURRENT TIME, pressing and releasing select switch 60 sequentially to select current hour and minutes.

The timer circuit is activated by moving to TIMER on the menu which is brought up on screen 52 by actuating set switch 58, holding for five seconds until the menu appears on the graphics display 52 at which time set switch 58 is released. Two options are available with the timer operation, AUTO TIMER and SELF TIMER. Auto timer is set by activating set switch 58 until the auto timer menu appears on the graphics display 52 and then is released. Hours and minutes are then available for selection through set switch 58 and select switch 60 as previously described.

If the self timer selection is desired, it can be brought forward as shown in FIGS. 15 and 16 where again hour and minute entry is effected through select switch 60 and set switch 58.

The timer function of device 40 can be automatically programmed to account for a shift to daylight savings time and to regular time again when that period ends thereby avoiding re-programming at those two times of the year.

CHARACTERS represents another item on the menu shown in FIG. 8, and GRAPHICS and ANIMATION options are available through the previously described process involving the sequential use of switches 58 and 60. FIGS. 17-20 illustrate the options available with this menu item.

A RECORD option is available as shown in FIG. 22, and ANNOUNCEMENT and REWARD options can be chosen so that an audible input can be made and played back in a programmed manner. Again the selective use of switches 58 and 60 carry through the various possibilities available in these modes.

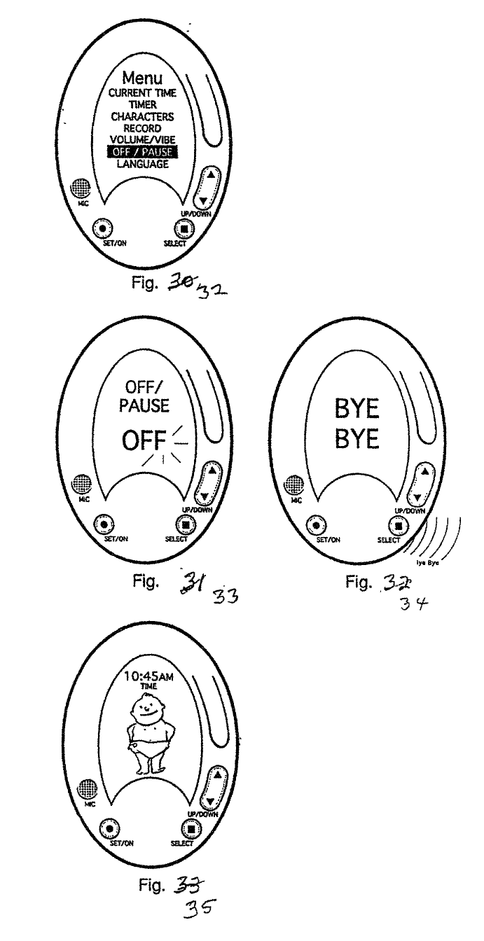

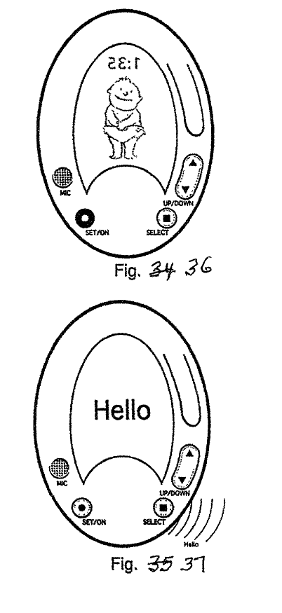

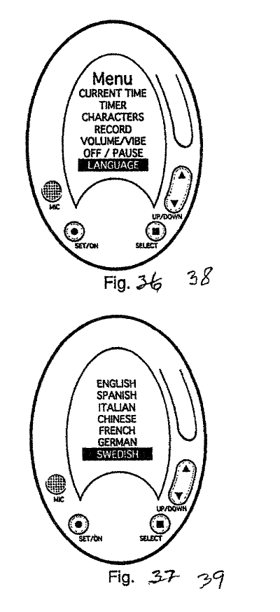

A VOLUME/VIBRATION function is shown in FIGS. 27-29 with VOLUME set at a selected intensity as shown in FIG. 28 and VIBRATION set as shown in FIG. 29.

An OFF/PAUSE option is shown in FIGS. 30-33 permitting the deactivation of the device for a selected period of time such as, for example, during the day trips or when staying with a friend. Appropriate visual and audio sign off signals can be programmed as reflected in FIGS. 30-33, and the regular programmed cycle of signals will not be interrupted so that when the device is reactivated, it will be on its previously programmed schedule.

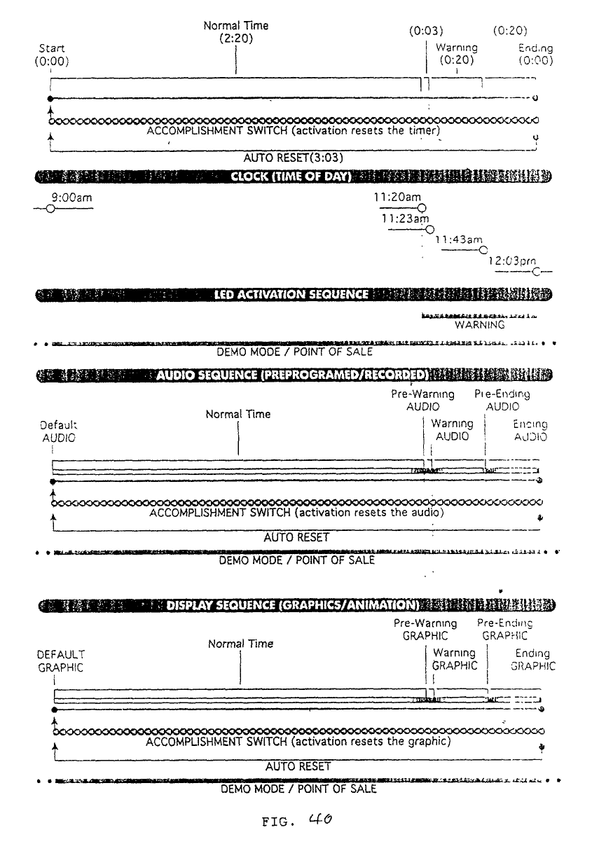

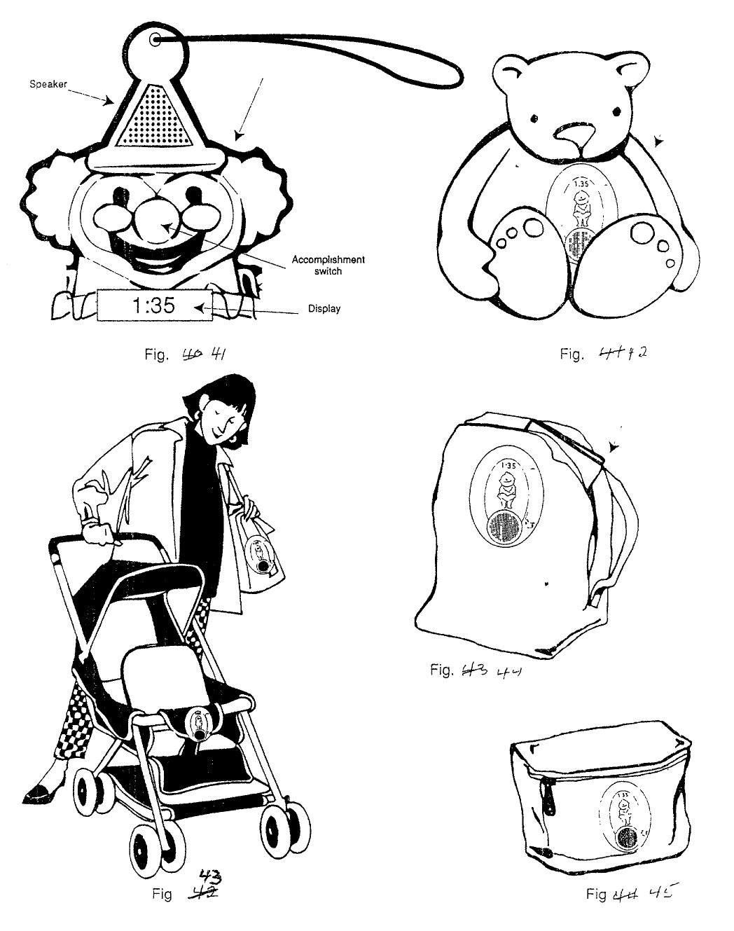

A LANGUAGE option is available as shown in FIGS. 36 and 37 selectable by the procedures detailed above.

A reset switch 61 is positioned on the rear side of shelf 48 and is used to entirely clear the device 40 when such clearance is needed. This can occur when the potty training of the toddler has been completed or when there has been a malfunction in the programming because of magnetic or static interference. Operating reset switch 61 will cause LED 65 to flash which will be the case when, for example, device 40 is displayed in a store and the flashing is an attraction to potential purchasers.

When device 40 is operated, a signal is produced and sensed by the appropriate action. It is meant to initiate activity on behalf of the participant such as visiting the bathroom in the event the participant is a child being potty-trained. If the event takes place and the child successfully completes the activity, he or she can activate the accomplishment switch 72 which operates the timer to recycle another normal time interval. Should the event not take place, the timer automatically initiates a first additional shorter time interval repeating the process and emitting another signal at the end of that short interval to hopefully give the participant another opportunity to carry out the activity. If the activity takes place, then accomplishment switch 72, when activated by the child, will then recycle the timer to start into another normal time interval. If the activity does not take place, the timer automatically initiates a second shorter time interval to provide yet another opportunity for the participant to carry out the activity. If no activity takes place, the timer automatically recycles for a normal time interval and the procedure repeats. A reward feature can be included within the operational format of accomplishment switch 72 by including a physical reward for the participant such as an openable container 86 (FIG. 51) having treats such as candy or gum or special graphically decorated potty training paper 88. The paper might have training aids such as the alphabet or cartoons which might hold a special interest for the participant.

The activity and operation of device 40 is graphically summarized in FIG. 40 wherein all functions are charted with specific time examples included for clarity.

In the event an accident occurs and the child has activity prior to the time of a scheduled event, away from the toilet, the parent activates the accomplishment switch so that recycling takes place.

Device 40 is programmed for night operation by selecting a time that the programs are discontinued with the visual and audio signals terminated but with the real time operation still in place. It is re-programmed to commence at a given time the next morning and begin the normal operation utilizing the selected number of pre-warnings and the established event time.

The timing intervals to be set by the timer circuit can be selectively done without any regard to the actual time an event will happen, however a fairly high degree of predictability can be obtained if the timer is set as an historical evaluation of the events that have taken place once the device has been placed in operation. An ongoing record of the actuation of the accomplishment switch can be reviewed and compared so that the intervals between the first, second and third events that occur can be evaluated, the interval can reset to coincide with a range of occurrences of those compared events. As these occurrences are grouped over time and the timer is programmed at these grouped times, the child will be aware of and alert to an alarm going off within that grouping and be more likely to participate in the activity suggested.

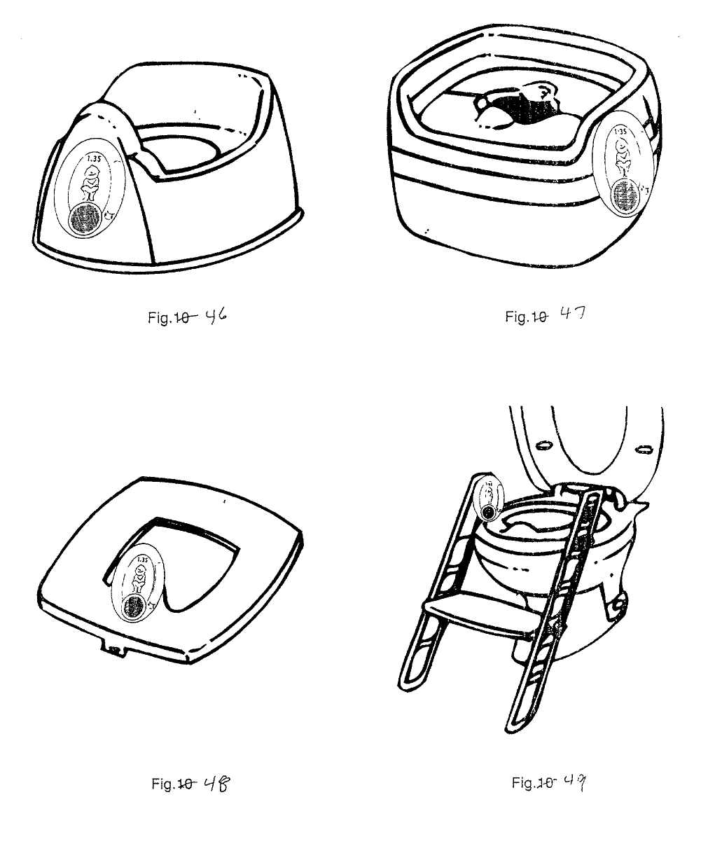

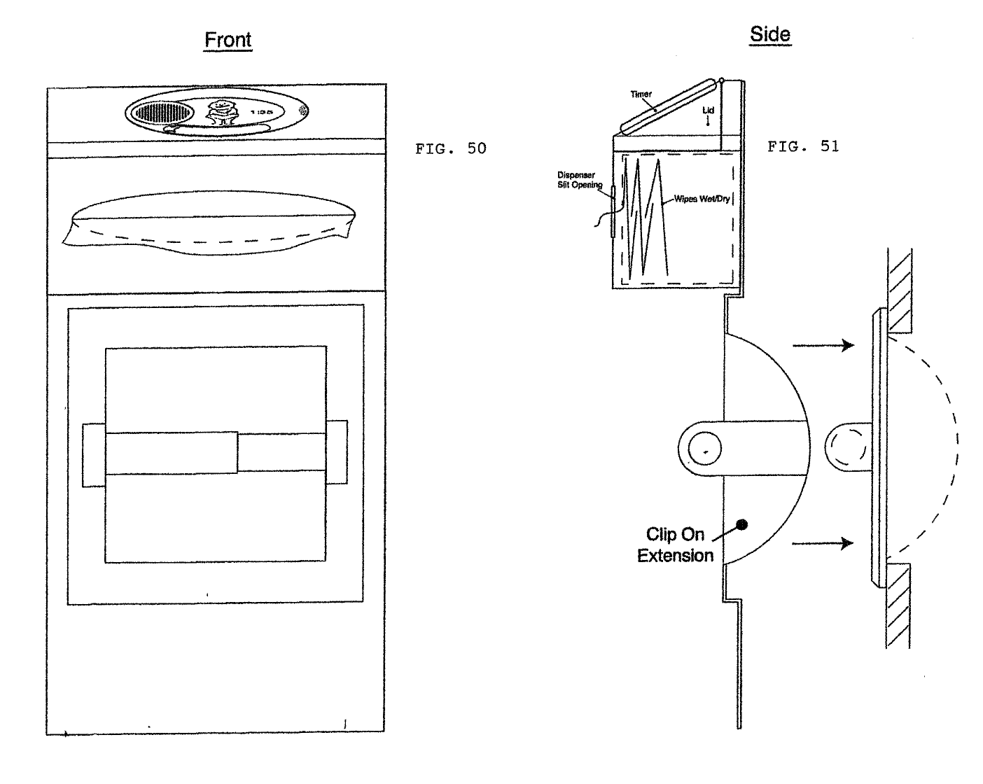

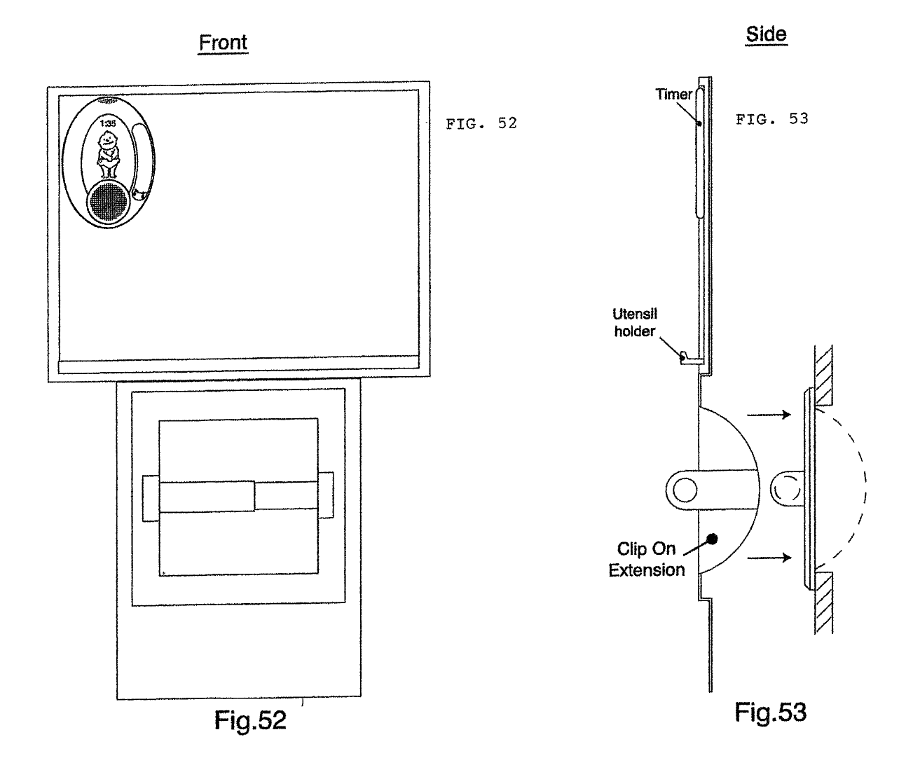

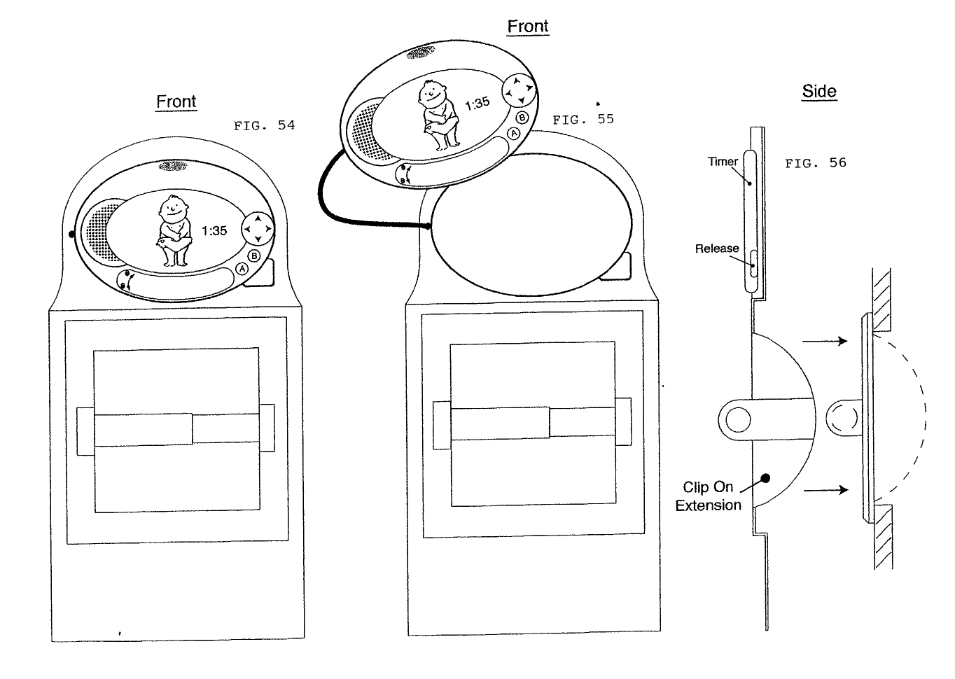

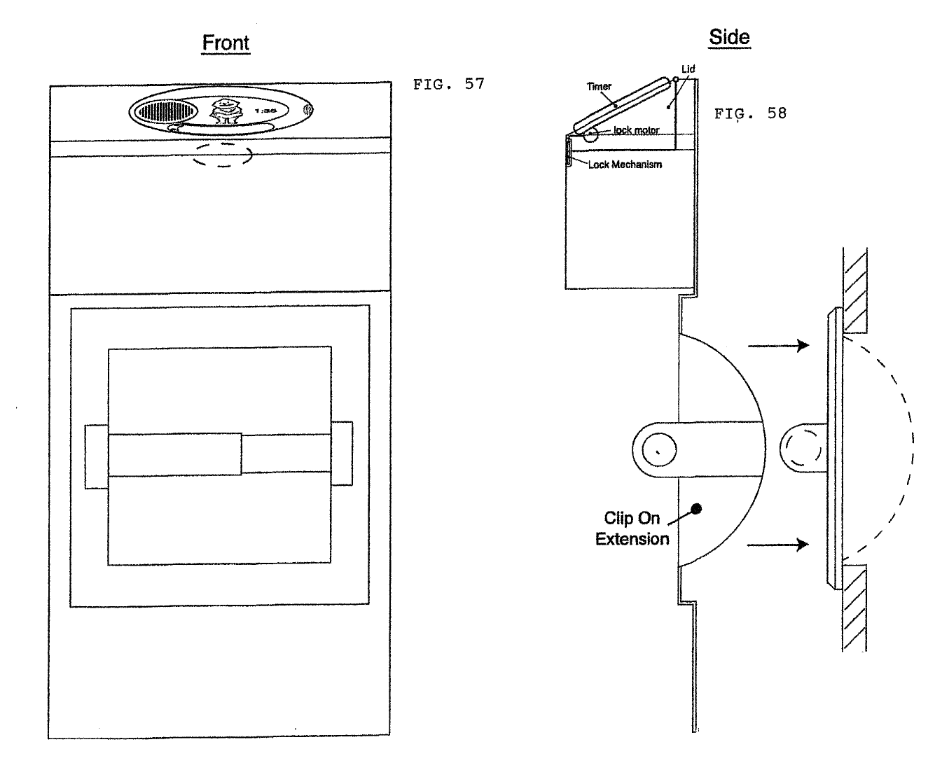

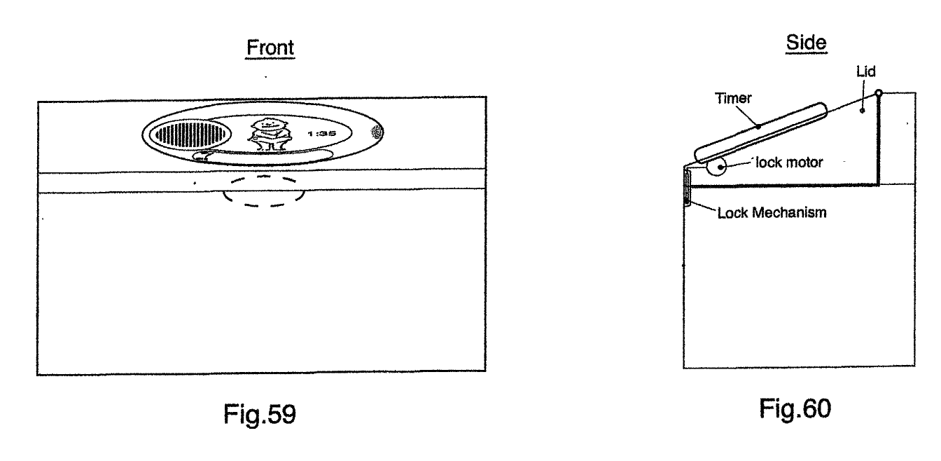

Device 40 can be utilized in a number of locations some of which are set forth in FIGS. 41-49. It can be positioned on or manufactured within a stuffed animal 74, a hanging toy 76, a diaper bag 78, a stroller 80, on the toilet 82, or any other convenient component.

The previous description presents the best mode contemplated in carrying out the present invention as depicted by the preferred embodiment disclosed. The combination of features illustrated by these embodiments provide its convenience of use and portability. The invention is, however, susceptible to modifications and alternate constructions from the embodiment shown in the drawing and described above. Consequently, there is no intention to limit it to the particular embodiment disclosed. To the contrary, the intention is to cover modifications and alternate constructions found within the scope of the invention as generally expressed by the following claims.

What is claimed is:

1. A device for conditioning subjects to perform specific tasks comprising: a signal circuit for producing a signal; and timer means connected to the signal circuit for setting a normal time interval and activating the signal circuit at the end of the time interval, the timer means including means for automatically initiating a selected number of additional shorter time intervals at the end of the normal time interval.

2. The device as claimed in claim 1 further comprising: an accomplishment switch operable with the timer means to interrupt and reset the timer means to the normal time interval upon actuation.

3. The device as claimed in claim 2 further comprising: visual means to display timer intervals and real time.

4. The device as claimed in claim 1 wherein the produced signal is audible.

5. The device as claimed in claim 1 wherein the produced signal is visual.

6. The device as claimed in claim 1 wherein the produced signal is vibratory.

7. The device as claimed in claim 1 wherein the timer means further includes means to produce an alert signal to indicate that a normal time interval signal will be activated at a future time.

8. The device as claimed in claim 3 further comprising: graphic means selectively displayed on the visual means.

9. The device as claimed in claim 8 further comprising: pause means for deactivating and reactivating the signal circuit, and the accomplishment switch.

10. The device as claimed in claim 5 further comprising: graphic means selectively displayed on the visual means, and pause means for deactivating and reactivating the signal circuit, and the accomplishment switch.

11. A device for conditioning subjects comprising: a housing; a signal circuit for producing a signal carried by the housing; timer means connected to the signal circuit for setting a normal time interval and activating the signal circuit at the end of the time interval, the timer means including means for automatically initiating additional shorter time intervals at the end of the normal time interval and having programming controls positioned on the housing; an accomplishment switch accessibly positioned on the housing and operable with the timer means to interrupt and reset the timer to the normal time interval when activated; visual means operably connected with the housing to display timer intervals; and a clock operably associated with the timer means to show the time remaining before the next signal activation on the visual means.

12. The device as claimed in claim 11 further comprising: a speaker proximate the housing to produce an audible signal and wherein the produced signal is audible.

13. The device as claimed in claim 12 further comprising: a microphone supported by the housing to receive audible signals and introduce the received signals to the speaker.

14. The device as claimed in claim 13 wherein the housing is an elliptical shell with a central opening, the visual means is a graphics display positioned within the opening, and further comprising: a hanger for supporting the housing; and a clip secured to the housing for maintaining the device against independent movement.

15. The device as claimed in claim 14 further comprising: a vibrator carried by the housing operable to receive a produced signal.

16. The device as claimed in claim 1 wherein a number of normal time intervals is set by comparing the first and subsequent manual operations of the accomplishment switch correlated to a 24 hour period and establishing the new normal time intervals ending at the times of peak probability of signal activation.

17. The device claimed in claim 15 wherein a number of normal time intervals is set by comparing the first and subsequent manual operations of the accomplishment switch correlated to a 24 hour period and establishing the new normal time intervals ending at the times of peak probability of signal activation.

18. The device as claimed in claim 1 further comprising: reward means selectively operable upon activation of the signal circuit to provide physical incentives to the subject upon successful task completion.

19. The device as claimed in claim 2 further comprising: reward means selectively operable by the accomplishment switch to provide physical incentives to the subject upon successful task completion.

20. The device as claimed in claim 11 further comprising: reward means selectively operable by the accomplishment switch to provide physical incentives to the subject upon successful task completion.

21. The device as claimed in claim 18 wherein the rewards means is a selectively openable container holding candy or other treats.

22. The device as claimed in claim 20 wherein the rewards means is a selectively openable container holding candy or other treats.
